(19) United States
(12) Patent Application Publication
(10) Pub. No.: US 2012/0044178 A1
(43) Pub. Date: Feb. 23, 2012

(54) Liquid Crystal Display Device with Built-In Touch Screen

(76) Inventor: InHyuk SONG, Gyeonggi-do (KR)

(21) Appl. No.: 13/210,578

(22) Filed: Aug. 16, 2011

(30) Foreign Application Priority Data
Aug. 19, 2010 (KR) 10-2010-0080323

(51) Int. Cl. G06F 3/041

(52) U.S. Cl. 345/173

(57) ABSTRACT

Disclosed is a liquid crystal display device with built-in touch screen, which facilitates to enhance electrostatic discharge (ESD) and touch-sensing efficiency, the LCD device with built-in touch screen comprising a lower substrate which has a pixel array including lines for defining a plurality of pixels, and electrodes for detecting a user's touch; a ground pad which is formed in the periphery of an active area on the lower substrate; an upper substrate which is bonded to the lower substrate with a liquid crystal layer interposed therebetween; a polarizing film which is provided on the upper substrate, the polarizing film for polarizing light emitted; a conductive adhesive layer which is formed of a conductive adhesive material on the upper substrate, the conductive adhesive layer for adhering the polarizing film to the upper substrate; a contact electrode which is provided on the upper substrate, and is electrically connected with the conductive adhesive layer; and a conductive layer which is electrically connected with the contact electrode and the ground pad.

### CROSS REFERENCE TO RELATED APPLICATIONS

This application claims the benefit of the Korean Patent Application No. 10-2010-0080323 filed on Aug. 19, 2010, which is hereby incorporated by reference as if fully set forth herein.

### BACKGROUND OF THE INVENTION

1. Field of the Invention

The present invention relates to a flat panel display device, and more particularly, to a liquid crystal display device with built-in touch screen, which facilitates to enhance electrostatic discharge (ESD) and touch-sensing efficiency.

2. Discussion of the Related Art

According to advancement of various mobile electronic equipments such as mobile terminal such as notebook computer, there is the increasing demand for an applicable flat panel display device.

The flat panel display device may include a liquid crystal display device (LCD), a plasma display panel (PDP), a field emission display device (FED), an organic light-emitting diode display device, and etc.

Among the various flat panel display devices, the LCD device is widely used owing to various advantages, for example, technical development for the mass production, easiness of driving means, low power consumption, high-quality resolution, and large-sized screen.

Generally, the LCD device includes a display panel having lower and upper substrates confronting each other with a liquid crystal layer interposed therebetween. Also, the LCD device includes a driving circuit which applies driving voltage and signal to the display panel.

The LCD device displays an image in accordance with a video signal by adjusting transmittance of light passing through the liquid crystal layer of each of a plurality of pixels (cells) in accordance with a data voltage.

Instead of a related art mouse or keyboard used as an input device of the flat panel display device, a touch screen is recently used as a new input device for the flat panel display device, wherein the touch screen enables a user to directly input information by the use of finger or pen.

The touch screen has been widely applied in various fields, for example, mobile terminals such as navigation, terminal for industrial use, notebook computer, automatic teller machine (ATM), mobile phone, MP3, PDA, PMP, PSP, mobile game machine, DMB receiver, and tablet PC; and electric appliances such as refrigerator, microwave oven, and washing machine. Furthermore, an easy operational method of the touch screen rapidly enlarges the application field.

On application of touch screen to the LCD device, an additional touch screen (touch panel) is added on a liquid crystal panel. Recently, an LCD device with built-in touch screen inside a liquid crystal panel has been researched and developed actively for realizing slimness.

FIGS. 1 to 3 illustrate an LCD device with built-in touch screen according to the related art. FIG. 3 is a cross section view along A-A′ of the LCD device with built-in touch screen of FIG. 2.

Referring to FIGS. 1 to 3, the LCD device 10 with built-in touch screen according to the related art adjusts transmittance of light passing through a liquid crystal layer of each pixel in accordance with a data voltage, to thereby display an image in accordance with a video signal. Also, the LCD device 10 with built-in touch screen according to the related art detects a touching point (TS) by sensing a change of capacitance (Ctc) in accordance with a user's touch.

For this, the LCD device 10 with built-in touch screen according to the related art includes a lower substrate 50, an upper substrate 60, and the liquid crystal layer (not shown), wherein the lower and upper substrates 50 and 60 are bonded to each other with the liquid crystal layer (not shown) interposed therebetween.

On the upper substrate 60, there are a black matrix 62; red, green, and blue color filters 64R, 64G, and 64B; and an overcoat layer 66. In this case, the black matrix 62 defines a pixel region corresponding to each of plural pixels. Also, the red, green, and blue color filters 64R, 64G, and 64B are respectively formed in the respective pixel regions defined by the black matrix 62. The overcoat layer 66 covers the red, green, and blue color filters 64R, 64G, and 64B and the black matrix 62, to thereby planarize the upper substrate 60.

On the lower substrate 50, there is a pixel array 40 including plural pixels to drive the liquid crystal layer and to detect a touching point by finger or pen.

Each of the plural pixels is defined by gate and data lines (not shown) intersecting each other. Each of the plural pixels includes a common electrode (not shown) to be applied with a common voltage, and a pixel electrode (not shown) for supplying a data voltage to the pixel. In this case, the common electrode and the pixel electrode may be formed of a transparent conductive material such as Indium-Tin-Oxide (ITO).

In each of the plural pixels, a thin film transistor (TFT) is switched in accordance with a gate signal applied through the gate line. According to the data voltage applied to the data line, an electric field is formed so that the liquid crystal layer is driven.

For a display period, each of the plural pixels displays the image in accordance with the video signal. Meanwhile, for a non-display period in which the image is not displayed, each of the plural pixels drives the common electrode of the pixel array 40 as a sensing/driving electrode to detect the touch, to thereby detect the touch by the finger or pen.

According to the user's touch, a touch capacitance (Ctc) is formed between the upper substrate 60 and the common electrode. The touch point (TS) is detected by comparing the touch capacitance (Ctc) with a reference capacitance, and the detected touch position is outputted to the external.

As shown in FIGS. 2 and 3, a rear electrode 20 for electrostatic discharge (ESD) is deposited on the upper substrate 60 of the LCD device 10 with built-in touch screen according to the related art. At this time, a polarizing film 68 for polarizing the light emitted from the liquid crystal panel is formed on the rear electrode 20.

Electric charge, which is formed in the rear electrode 20 by electrostatic induction, is discharged to ground (GND) through a ground pad 30 formed in the lower substrate 50. For this, the rear electrode 20 and the ground pad 30 are electrically connected with each other by a conductive layer 70.

In the LCD device 10 with built-in touch screen according to the related art, the rear electrode 20 of transparent conductive material such as ITO is formed on the color filter of the upper substrate 60, thereby facilitating the electrostatic discharge (ESD).

Meanwhile, in case of projected cap type touch in-cell LCD device where the touch screen is built in the liquid crystal panel, the rear electrode 200 is formed of the transparent conductive material such as ITO. However, the rear electrode 200 may lower the detection efficiency of the user's touch and light transmittance.

If the rear electrode 20 has low resistance, the rear electrode 20 with the low resistance shields the effect of the user's finger, thereby resulting in the deteriorated touch detection efficiency.

If the rear electrode 20 is thick, the light transmittance is lowered.

As the rear electrode 20 is formed on the entire surface of the upper substrate 60, the manufacturing efficiency is lowered and the manufacturing cost is increased.

The problems of the low touch detection efficiency and the deteriorated luminance may be overcome by forming the rear electrode 20 with high resistance, and increasing the number of light sources to supply light to the liquid crystal panel.

However, the manufacturing cost is increased due to the increase of light sources, and the power consumption is also increased in proportion to the increased number of light sources.

### SUMMARY OF THE INVENTION

Accordingly, the present invention is directed to an LCD device with built-in touch screen that substantially obviates one or more problems due to limitations and disadvantages of the related art.

An aspect of the present invention is to provide an LCD device with built-in touch screen, which facilitates to enhance touch-sensing efficiency.

Another aspect of the present invention is to provide an LCD device with built-in touch screen, which facilitates to improve luminance by increasing light transmittance.

Another aspect of the present invention is to provide an LCD device with built-in touch screen, which facilitates to improve manufacturing efficiency.

Another aspect of the present invention is to provide an LCD device with built-in touch screen, which facilitates to enhance electrostatic discharge efficiency.

A further aspect of the present invention is to provide an LCD device with built-in touch screen, which facilitates to enhance touch-sensing efficiency and light transmittance without increasing manufacturing cost and power consumption.

Additional advantages and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these and other advantages and in accordance with the purpose of the invention, as embodied and broadly described herein, there is provided an LCD device with built-in touch screen comprising: a lower substrate which has a pixel array including lines for defining a plurality of pixels, and electrodes for detecting a user's touch; a ground pad which is formed in the periphery of an active area on the lower substrate; an upper substrate which is bonded to the lower substrate with a liquid crystal layer interposed therebetween; a polarizing film which is provided on the upper substrate, the polarizing film for polarizing light emitted; a conductive adhesive layer which is formed of a conductive adhesive material on the upper substrate, the conductive adhesive layer for adhering the polarizing film to the upper substrate; a contact electrode which is provided on the upper substrate, and is electrically connected with the conductive adhesive layer; and a conductive layer which is electrically connected with the contact electrode and the ground pad.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1 to 3 illustrate an LCD device with built-in touch screen according to the related art;

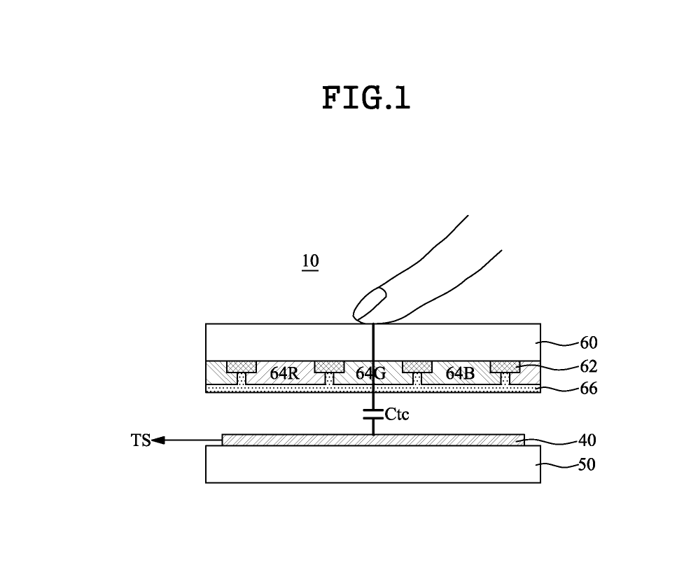

FIG. 4 is a plane view illustrating an LCD device with built-in touch screen according to the embodiment of the present invention;

FIG. 5 is a cross section view along B-B′ of the LCD device with built-in touch screen of FIG. 4;

FIG. 6 is a cross section view along C-C′ of the LCD device with built-in touch screen of FIG. 4; and

FIG. 7 is a cross section view along D-D′ of the LCD device with built-in touch screen of FIG. 4.

### DETAILED DESCRIPTION OF THE INVENTION

Reference will now be made in detail to the exemplary embodiments of the present invention, examples of which are illustrated in the accompanying drawings. Wherever possible, the same reference numbers will be used throughout the drawings to refer to the same or like parts.

Hereinafter, an LCD device with built-in touch screen according to the present invention and a method for manufacturing the same will be described with reference to the accompanying drawings.

The LCD device with built-in touch screen according to the embodiment of the present invention includes a liquid crystal display module, and a driving circuit for driving the liquid crystal display module.

The liquid crystal display module includes a liquid crystal panel (In-Plane Switching mode) with built-in touch screen for detecting a user's touch point, and a backlight unit for supplying light to the liquid crystal panel.

The driving circuit includes a timing controller, a data driver, a gate driver, a backlight driver, a common voltage supplier, a touch sensing driver, and a power supplier.

The timing controller generates digital video data (R, G, B) by aligning externally-provided video signals in unit of frame, and generates driving control signals (DCS, GCS) for data and gate drivers.

The data driver supplies a data signal (voltage) to each pixel of the liquid crystal panel in accordance with the video signal.

The gate driver supplies a scan signal to each pixel of the liquid crystal panel.

The touch sensing driver detects the user's touch point by sensing a change of capacitance based on the user's touch.

The backlight driver drives a light source of the backlight unit.

The common voltage supplier supplies a common voltage (Vcom) to a common electrode of the liquid crystal panel.

For example, the driving circuit may be formed outside the liquid crystal panel.

According to another example, the driving circuit may be formed on the liquid crystal panel by COG (Chip On Glass) or COF (Chip On Flexible Printed Circuit, Chip On Film).

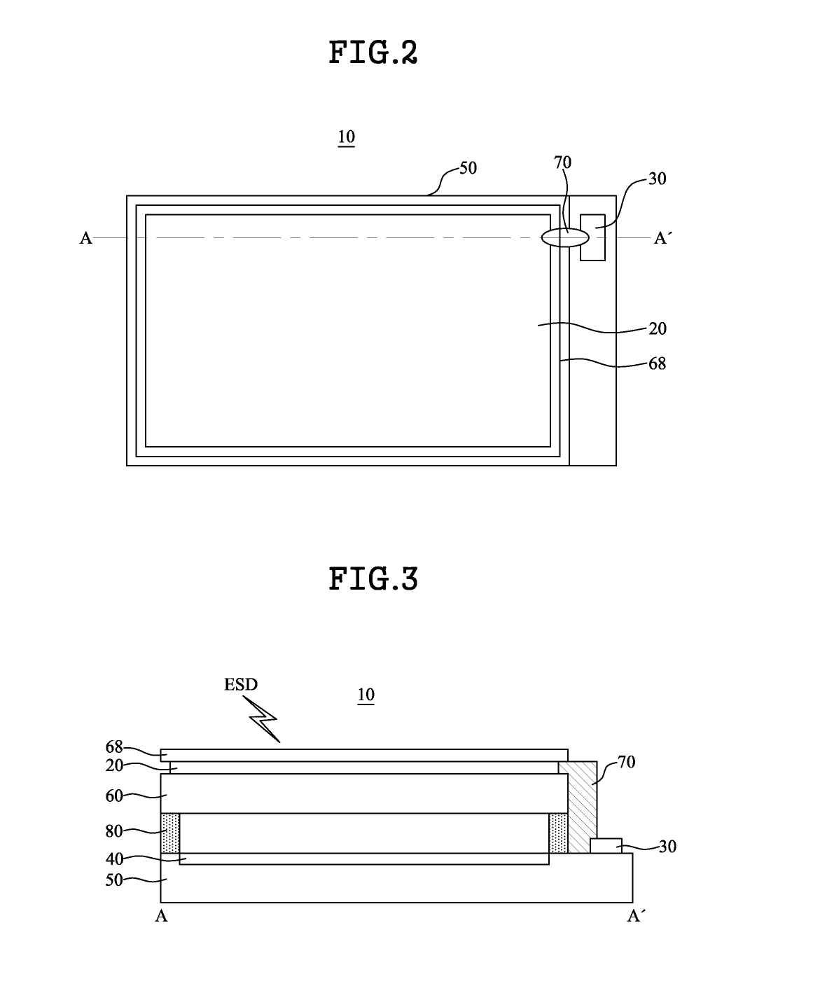

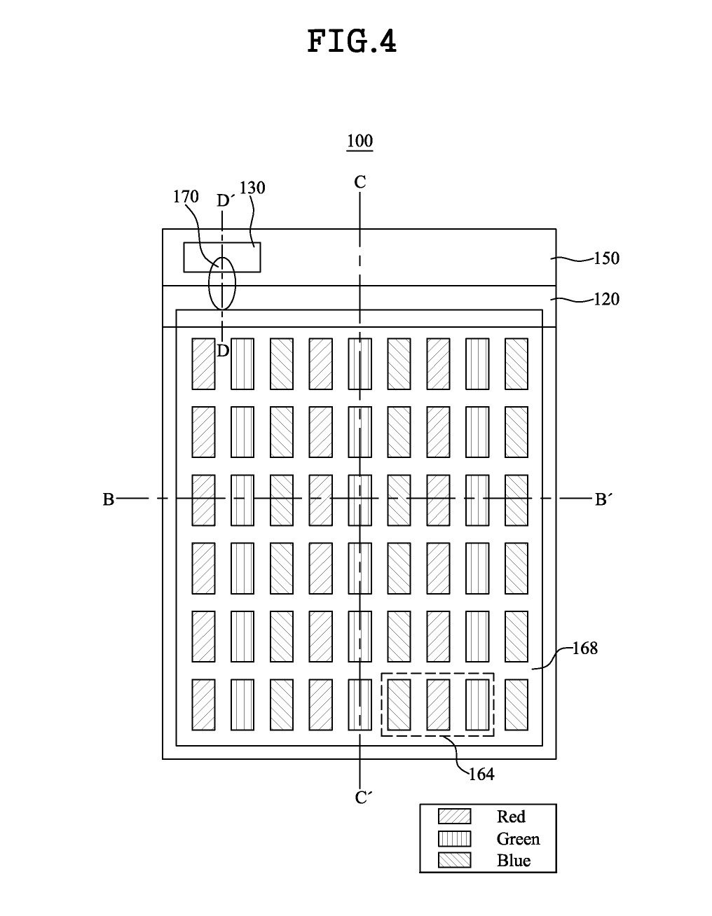

FIGS. 4 to 7 illustrate an LCD device with built-in touch screen according to the embodiment of the present invention.

Referring to FIGS. 4 to 7, the LCD device 100 with built-in touch screen according to the embodiment of the present invention includes a lower substrate 150 and an upper substrate 160, wherein the lower and upper substrates 150 and 160 are bonded to each other with a liquid crystal layer interposed therebetween by the use of sealant (not shown).

The LCD device 100 with built-in touch screen according to the embodiment of the present invention displays an image in accordance with a video signal by adjusting transmittance of light passing through the liquid crystal layer in accordance with a data voltage applied to each pixel. Also, the LCD device 100 with built-in touch screen according to the embodiment of the present invention detects a user's touch point by sensing a change of capacitance based on a user's touch through a pixel array 140.

The lower and upper substrate 150 and 160 are bonded to each other by the use of sealant, whereby a display area for displaying the image is shielded from the external.

On the lower substrate 150, there is the pixel array 140 which is obtained by forming a plurality of pixels (Clc, liquid crystal cell) and sensing/driving electrodes for detecting the user's touch in a matrix configuration. In this case, the user's touch point is detected by the change of capacitance.

The pixel array 140 of the lower substrate 150 displays the image, wherein the pixel array 140 includes a plurality of lines (gate line, data line, common voltage line) for detecting the user's touch point. In this case, the common voltage line is used as a sensing/driving line for detection of the touch point.

On the lower substrate 150, there are plural metal lines which supply driving signals (voltages) to the plurality of lines.

In more detail, the lower substrate 150 includes ‘m’ data lines, and ‘n’ gate lines. A plurality of pixels (Clc) for displaying the image may be defined by intersection of the gate and data lines.

Each pixel includes a thin film transistor (TFT) and a storage capacitor (Cst) which are formed adjacent to each intersection of the gate and data lines.

In response to a scan signal supplied via the gate line, the thin film transistor (TFT) supplies the data voltage supplied via the data line to the pixel (Clc).

According as the thin film transistor (TFT) is switched in accordance with the scan signal (gate driving signal) applied via the gate line, each of the pixels is turned-on.

The turned-on pixel drives the liquid crystal layer by forming an electric field in accordance with the data voltage applied via the data line, and a common voltage (Vcom).

For this, a pixel electrode (pixel ITO) is formed in each of the plural pixels, wherein the pixel electrode supplies the data voltage to the pixel in accordance with the video signal. In this case, a common electrode (Vcom ITO) to be supplied with the common voltage (Vcom) is formed in each of the plural pixels.

The pixel electrode and the common electrode may be formed of a transparent conductive material such as ITO (Indium Tin Oxide).

Each of the plural pixels includes the sensing/driving electrode in the pixel array 140, wherein the sensing/driving electrode detects the user's touch for a non-display period which does not display the image.

In this case, the sensing/driving electrode functions as the common electrode to supply the common voltage (Vcom) for a display period which displays the image. That is, the sensing/driving electrode is driven as the common electrode for the display period, and is also driven as the sensing/driving electrode to detect the user's touch for the non-display period.

According to the user's touch, there is the touch capacitance (Ctc) between the upper substrate of each pixel and the sensing/driving electrode. The user's touch point is detected by comparing the touch capacitance (Ctc) based on the touch with a reference capacitance, and then the detected touch point is outputted to the external.

On the lower substrate 150, there is a ground pad 130 which is provided to ground (GND) electric charges formed on the display panel by static electricity.

The ground pad 130 is formed in the periphery of an active area of the lower substrate 150. The ground pad 130 is electrically connected with a contact electrode 120 to be explained by the use of conductive layer 170.

The upper substrate 160 is formed by using a light-transmittable glass substrate as a base substrate. The upper substrate 160 includes a light-shielding layer (black matrix, BM) 162 which is formed an opaque conductive material for defining the plurality of pixels; red, green and blue color filters 164 which are formed in the respective pixels defined by the light-shielding layer 162; and an overcoat layer 166 which covers the light-shielding layer 162 and the color filters 164 so as to planarize the upper substrate 160.

On the upper substrate 160, there is a polarizing film 168 for polarizing light. The polarizing film 168 is adhered to the upper substrate 160 by the use of conductive adhesive layer 180 formed on an entire surface of the upper substrate 160.

The conductive adhesive layer 180 is electrically connected with the contact electrode 120 to be explained.

Optically, the conductive adhesive layer 180 is formed of a transparent material to transmit the light emitted from the liquid crystal panel.

Electrically, the conductive adhesive layer 180 is formed of a conductive material with conductivity for grounding the electric charges formed on the liquid crystal panel by static electricity to the ground pad 130 of the lower substrate 150.

The conductive adhesive layer 180 has high resistance for enhancing the efficiency in detection of the user's touch point, for example, 50 MΩ/sqr˜5 GΩ/sqr.

The contact electrode 120 is electrically connected with the conductive adhesive layer 180 to adhere the polarizing film 168 to the upper substrate 160.

Also, the contact electrode 120 is electrically connected with the conductive layer 170 which is electrically connected with the ground pad 130 on the lower substrate 150.

For this, the contact electrode 120 is formed at a predetermined portion of one side in the periphery of the active area of the upper substrate 160 for displaying the image.

Also, the contact electrode 120 is partially overlapped with one side of the conductive adhesive layer 180 formed to adhere the polarizing film 168 to the upper substrate 160.

The conductive adhesive layer 180 is electrically connected with the contact electrode 120. In this case, a resistance value of the contact electrode 120 is lower than a resistance value of the conductive adhesive layer 180 so as to easily discharge the electric charges formed on the liquid crystal panel into the ground.

The contact electrode 120 may be formed of any one transparent conductive material of ITO (Indium Tin Oxide), IZO (Indium Zinc Oxide), ZnO, ZnO:B, ZnO:Al, SnO2, SnO2:F, ITZO (Indium Tin Zinc Oxide), ZTO (Zinc Tin Oxide), and ATO (Antimony Tin Oxide).

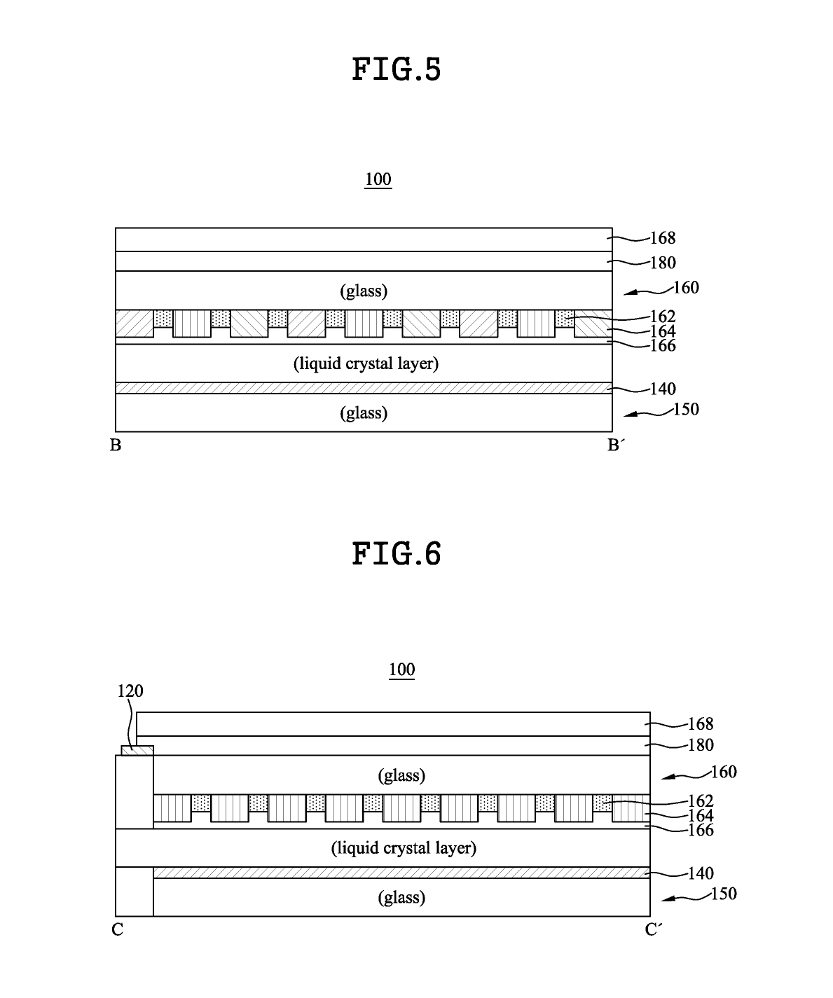

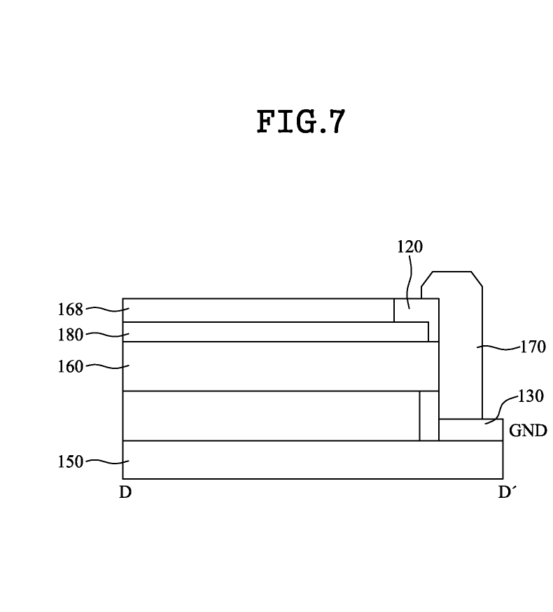

The conductive layer 170 is formed of a paste or tape including the conductive material such as argentums Ag. As shown in FIGS. 6 and 7, the conductive layer 170 is electrically connected with the contact electrode 120 on the upper substrate 160, and is also electrically connected with the ground pad 130 on the lower substrate 150.

In the above LCD device 100 with built-in touch screen according to the embodiment of the present invention, the electric charges formed on the liquid crystal panel by the static electricity are discharged into the ground (GND) via the conductive adhesive layer 180, the contact electrode 120, the conductive layer 170, and the ground pad 130 being electrically connected with one another.

The conductive adhesive layer 180 and the contact electrode 120 partially surface-contact with each other at one side of the upper substrate 160, thereby enhancing the electrostatic discharge efficiency in the LCD device with built-in touch screen.

As mentioned above, the conductive adhesive layer 180 is formed of the material with the high resistance value of 50 MΩ/sqr˜5 GΩ/sqr, thereby preventing the effect of the user's finger from being shielded. Accordingly, the LCD device with built-in touch screen according to the present invention enhances the touch detection efficiency.

The contact electrode 120 is formed only in the predetermined portion of one side of the upper substrate 160. Thus, a shadow mask for the manufacturing process may be simplified in design. Also, a margin of the manufacturing process may be increased.

The LCD device with built-in touch screen according to the embodiment of the present invention realizes the electrostatic discharge without the rear electrode applied to the related art, and furthermore enhances the luminance efficiency by improvement of light transmittance.

In addition, there is no requirement for the additional light sources owing to the enhanced luminance efficiency, thereby resulting in the reduced manufacturing cost. Also, it is possible to prevent the increase of power consumption.

Accordingly, the LCD device with built-in touch screen according to the present invention enhances the touch detection efficiency, enhances the luminance by the improved light transmittance, improves the manufacturing efficiency, realizes the improved electrostatic discharge efficiency, improves the touch detection efficiency and light transmittance without the increase in power consumption and manufacturing cost, and decreases the thickness of the device by providing the built-in means for the electrostatic discharge inside the liquid crystal panel.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An LCD device with built-in touch screen comprising:
a lower substrate which has a pixel array including lines for defining a plurality of pixels, and electrodes for detecting a user's touch;
a ground pad which is formed in the periphery of an active area on the lower substrate;
an upper substrate which is bonded to the lower substrate with a liquid crystal layer interposed therebetween;
a polarizing film which is provided on the upper substrate, the polarizing film for polarizing light emitted;
a conductive adhesive layer which is formed of a conductive adhesive material on the upper substrate, the conductive adhesive layer for adhering the polarizing film to the upper substrate;
a contact electrode which is provided on the upper substrate, and is electrically connected with the conductive adhesive layer; and
a conductive layer which is electrically connected with the contact electrode and the ground pad.

2. The LCD device according to claim 1, wherein the conductive adhesive layer has a resistance value of 50 MΩ/sqr˜5 GΩ/sqr.

3. The LCD device according to claim 1, wherein the conductive adhesive layer has a resistance value which is higher than that of the contact electrode.

4. The LCD device according to claim 1, wherein the contact electrode is formed in the periphery of the active area on the upper substrate.

5. The LCD device according to claim 4, wherein the contact electrode is formed at a predetermined portion of one side of the upper substrate.

6. The LCD device according to claim 4, wherein the contact electrode is electrically connected with a predetermined portion of the conductive adhesive layer.

7. The LCD device according to claim 4, wherein the contact electrode is formed of any one transparent conductive material of ITO (Indium Tin Oxide), IZO (Indium Zinc Oxide), ZnO, ZnO:B, ZnO:Al, SnO2, SnO2:F, ITZO (Indium Tin Zinc Oxide), ZTO (Zinc Tin Oxide), and ATO (Antimony Tin Oxide).

8. The LCD device according to claim 1, wherein the conductive adhesive layer, the contact electrode, the conductive layer, and the ground pad area electrically connected with one another so as to ground electric charged formed on a liquid crystal panel by static electricity.
